(19) United States
(12) Patent Application Publication
(10) Pub. No.: US 2008/0120126 A1
(43) Pub. Date: May 22, 2008

(54) Intelligent parallel processing system and method

(76) Inventor: George Bone, Silverspring, MD (US)

Correspondence Address: Maier & Maier, PLLC, 1000 Duke Street, Alexandria, VA, 22314, US

(21) Appl. No.: 11/785,151

(22) Filed: Apr. 16, 2007

Related U.S. Application Data
(60) Provisional application No. 60/860,211, filed on Nov. 21, 2006.

(51) Int. Cl. G06Q 10/00

(52) U.S. Cl. 705/1

(57) ABSTRACT

In one exemplary embodiment, a method and system for an automated intelligent parallel processing enabled architectural framework for supporting electronic human services (EHS) is disclosed. The system and method may include, for example, a methodology and process environment component having an intelligent parallel business process, a collaborative environment component, and a knowledge enablement and augmentation environment component that are operatively interconnected via an intelligent broker component/module.

### PRIORITY

This application claims priority, under 35 U.S.C. § 119(e), to U.S. Provisional Patent Application No. 60/860,211 filed Nov. 21, 2006, the entire disclosure of which is incorporated by reference in its entirety.

### FIELD

The present invention is related in general to architectural frameworks and, more particularly, to the use of effectively linked architectural frameworks supporting electronic human services.

### BACKGROUND

The electronic human services (EHSs) are the e-convenience services of healthcare, banking, finance, commerce, transportation, recreation, travel, entertainment industries and any other service that may be conveniently delivered electronically by any other industry. EHSs may be performed locally and/or globally via network enabled collaboration environments. Indeed, EHSs may very well benefit from network enabled collaboration environments that produce efficient, effective and automated enterprise EHSs and corresponding operations. A shortcoming of existing EHSs is their limited ability to capture domain-specific knowledge and act on this knowledge in an automated fashion.

Further, the EHS industries disclosed above—healthcare, banking, finance, commerce, transportation, recreation, travel and entertainment—are multi-trillion dollar industries. For example, the annual global expenditure for healthcare, according to some, exceeds three trillion dollars. This expenditure is approximately 8 percent of the world's gross domestic product (GDP). Healthcare spending in the United States alone is estimated by some to be over one trillion dollars; thus, it represents the largest sector of the U.S. economy. The enormous scale of these industries offers a huge potential for cost savings that is not fully realized by existing EHS systems.

Commercial Off-The-Shelf (COTS) software components such as databases, user interface frameworks and configuration management software packages provide many of the building blocks necessary to create an improved EHS system. However, several additional concepts are necessary to effectively capture the domain-specific knowledge and potential cost savings lacking in existing EHS systems. Exemplary embodiments of the present invention disclose a unified architectural framework that results in a comprehensive and robust solution to any number of problem domains.

### SUMMARY

In at least one exemplary embodiment, an Automated Intelligent Parallel Process Solution (AIPPS)-enabled open Enterprise Architectural Framework (EAF) is disclosed that may include a Methodology and Process Environment (MPE) component, a Collaborative Environment (CE) component, and a Knowledge Enablement and Augmentation (KEA) environment component that are operatively interconnected via an Intelligent Broker (IB) component/module.

In accordance with at least one other exemplary embodiment, an AIPPS system and method for integrating an EAF having an MPE component may have an intelligent and automated parallel business process module that may further comprise an Initiation sub-process, an Evaluation sub-process, a Formulation sub-process and a Communication sub-process.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is an exemplary diagram showing a computer system.

FIG. 2 is an exemplary figure showing an exemplary embodiment of building blocks for an exemplary Enterprise Architectural Framework (EAF).

FIG. 3 is an exemplary figure showing an exemplary embodiment of an EAF enabled by an Automated Intelligent Parallel Processing Solution (AIPPS) business process module.

FIG. 4 is an exemplary figure showing an exemplary intelligent and automated parallel business process for use in a Methodology and Process Environment (MPE) component of an exemplary EAF.

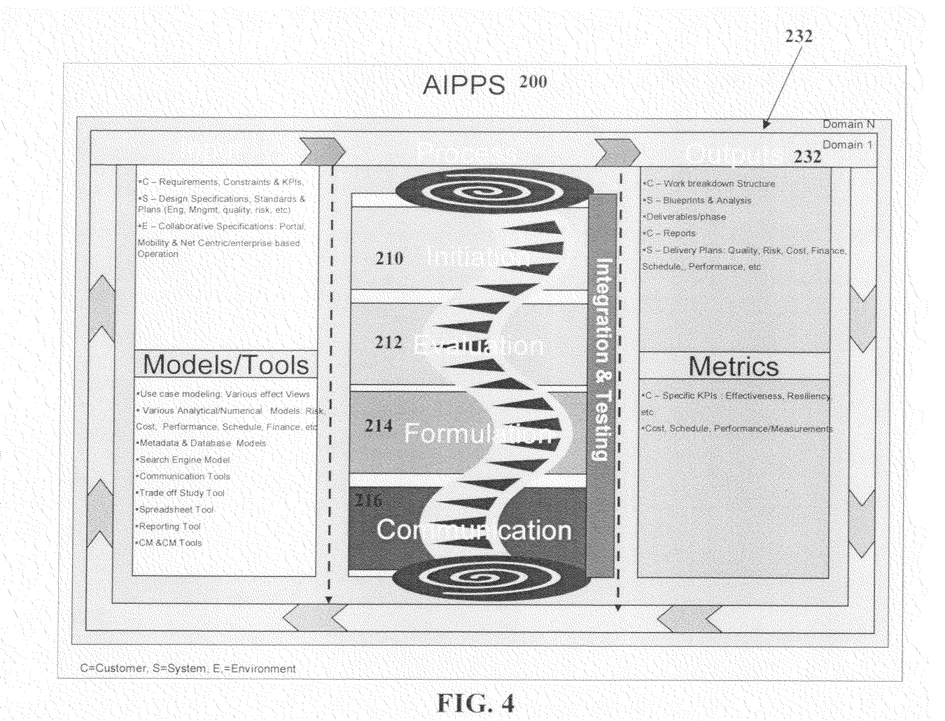

FIG. 5 is an exemplary figure of an integrated and operatively interconnected EAF having an intelligent and automated parallel business processing module.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence of actions described herein can be considered to be embodied entirely within any form of computer readable storage medium having stored therein a corresponding set of computer instructions that, upon execution, would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

To facilitate an understanding of the description discussion of several terms used herein follows.

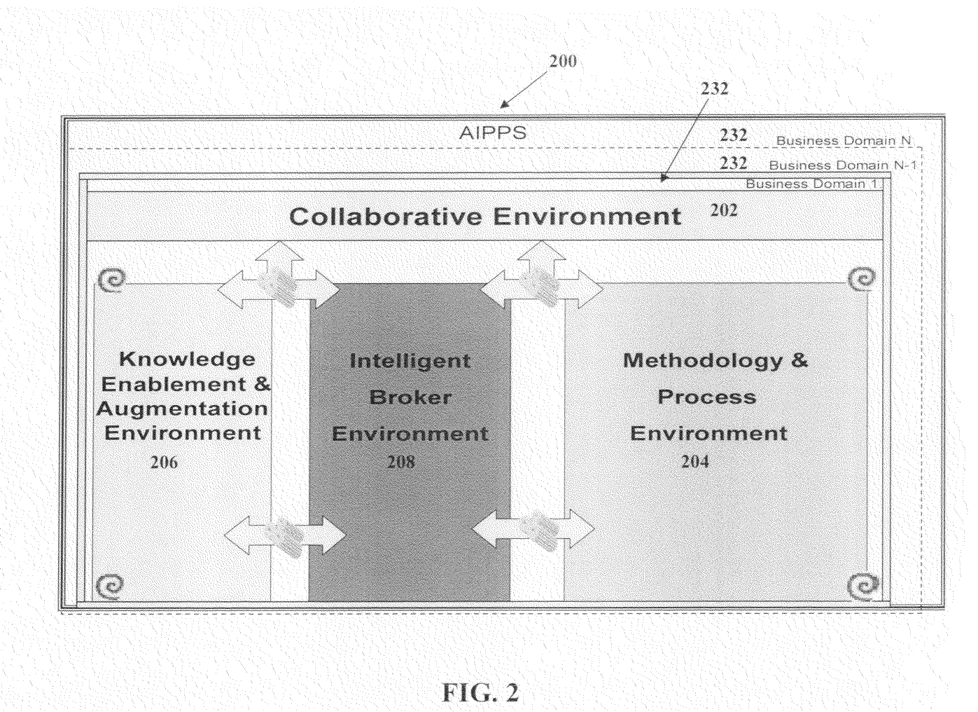

The “Automated Intelligent Parallel Process Solution (AIPPS)” is an architectural framework comprising four key differentiating integrated building blocks as depicted in FIG. 2. These building blocks are the Collaborative Environment (CE), Methodology and Process Environment (MPE), Intelligent Broker (IB) environment, and Knowledge Enablement and Augmentation (KEA) Environment. Each of these building blocks is based on viable/proven methodology and technology that exist today.

“Change Management” refers to a process/component that: manages each request for change, in a manner that provides full traceability; ensures that each request for change is assessed by key stakeholders; ensures that each assessed change request is accepted, rejected, or deferred by the appropriate authority; enables the orderly implementation of each accepted change; and allows the impact of all changes to be understood, documented and managed. The primary focus of change management is on those changes that are introduced by problem domain specialists, such as changes to requirements or the content of deliverables.

The “Collaboration module” is the component that provides a Graphical User Interface (GUI) and the logic necessary for multiple users to interact. It is the collection of components/software that implements the Collaborative Environment (CE).

The “Collaborative Environment (CE)” of the exemplary embodiment allows two or more participants to communicate, coordinate and collaborate to accomplish a shared task or objective, and to reach a decision(s). In addition, the exemplary embodiment having a CE may provide users with web enabled communication and collaboration abilities across multiple geographic sites and between various users spread across multiple internet domains, sites and time zones. The CE may be constructed from a range of computer and communication technologies, such as instant messaging, e-mail, electronic forums, chat rooms, discussion databases, mobile communicators, shared white boards, streaming media including audio, video or web conferences or any other collaborative technologies known to one having ordinary skill in the art.

“Configuration Management (CM)” system refers to a system that maintains a list of processes, tooling, resources for compliance with open standard guidelines, documents, or software versions and a cross-listed matrix that indicates the relationships between these items. CM should be substantially: (1) Controllable—all aspects of managed items are placed under configuration control to be readily identified and managed; (2) Reproducible—any previous version of the scenario artifacts and/or configurations (baselines) can be reproduced; and (3) Measurable—provide metrics for Use Case status and issues for use by operation management to make decisions and report on scenario performance.

“Configuration Management Plan” refers to the logical set of rules that govern how items that are under CM may be added, removed, modified, stored, activated, deactivated, combined and deployed to the actively operating architectural framework. Interface management control measures ensure that all internal and external interface requirement changes are properly documented in accordance with the Configuration Management Plan.

“Digital Media Solution (DMS)” refers to a component that stores, delivers, and provides access to digital content including but not limited to audio, video, images, data, and text.

“Electronic Convenience Services” are services that may be provided or facilitated through the intelligent application of data and rules that are defined for a specific problem domain. Problem domains include but are not limited to healthcare, banking, finance, commerce, transportation, recreation, travel, and entertainment industries.

“Enterprise Architectural Framework (EAF)” is the amalgamation of products, applications, services, and/or enabling infrastructure that encompasses an Electronic Human Services problem domain.

“Intelligent messaging Broker” or “Intelligent Broker (IB)” handles requests or messages from one module or application to another. Multiple applications are able to simultaneously receive a particular message from any connected application that is publishing that message. An Intelligent Broker is able to perform any transformations that may be necessary in order to make the message decipherable to the target application.

“Intelligent routing” describes the manner in which an Intelligent Broker can identify the type and target of a message from a particular source application and route it to the appropriate target application.

The “Knowledge Enablement and Augmentation (KEA)” environment refers to the set of software tools and data that relate to the specific problem domain. In an exemplary embodiment, the KEA environment comprises a Search Engine, a Knowledge Management solution and Digital Media Solution.

The “Knowledge Management (KM)” solution is a component/process for leveraging and utilizing the vast potential of both tacit knowledge and structured artifacts (tools, work products, code, solutions, techniques, templates, etc.) relevant to a problem domain.

“Methodology and Process Environment (MPE)” refers to the framework that enables specialists in the problem domain to define their requirements and capture the multiplicity of business processes that define that domain. A spiral development methodology is applied throughout the lifetime of this framework so that improvements can be made as knowledge of the problem domain grows. US Patent application 20050096937 “Method of automation of business processes and apparatus therefor,” herein incorporated by reference, teaches a method and apparatus for capturing business processes.

“Spiral development methodology” refers to a methodology for software design that comprises iterative phases of analysis, design, prototyping/implementation and testing. The iterative nature of this methodology enables the phases to be conducted in parallel with refinements to the phases at each cycle through the spiral.

“Unified Modeling Language (UML)” refers to the standardized language for modeling software objects that can be applied to a variety of fields including software design, business process design and system design. See Object Management Group, “Unified Modeling Language: Superstructure,” August 2005, which is hereby incorporated by reference into this patent application.

“Web Browser Intelligence (WBI)” is the process of using intelligent agent technology to reduce the Internet's complexity, which may help users of all level of experience. WBI can accomplish this, for example, by: noticing patterns in Web browsing and suggesting shortcuts; automatically checking favorite Web pages for changes; testing the speed of links between pages; remembering a complete Web history, thus, possibly making it easier to return to a site; searching through previously viewed information to find an information source, letting users look back in “Web time” to see how they have visited pages in the past; and providing connectivity to both Proxy. and SOCKS servers. The WBI agent may be connected to a Web browser allowing it to capture information about each page a user may access. Over time, the agent may learn usage patterns well enough to predict users' patterns.

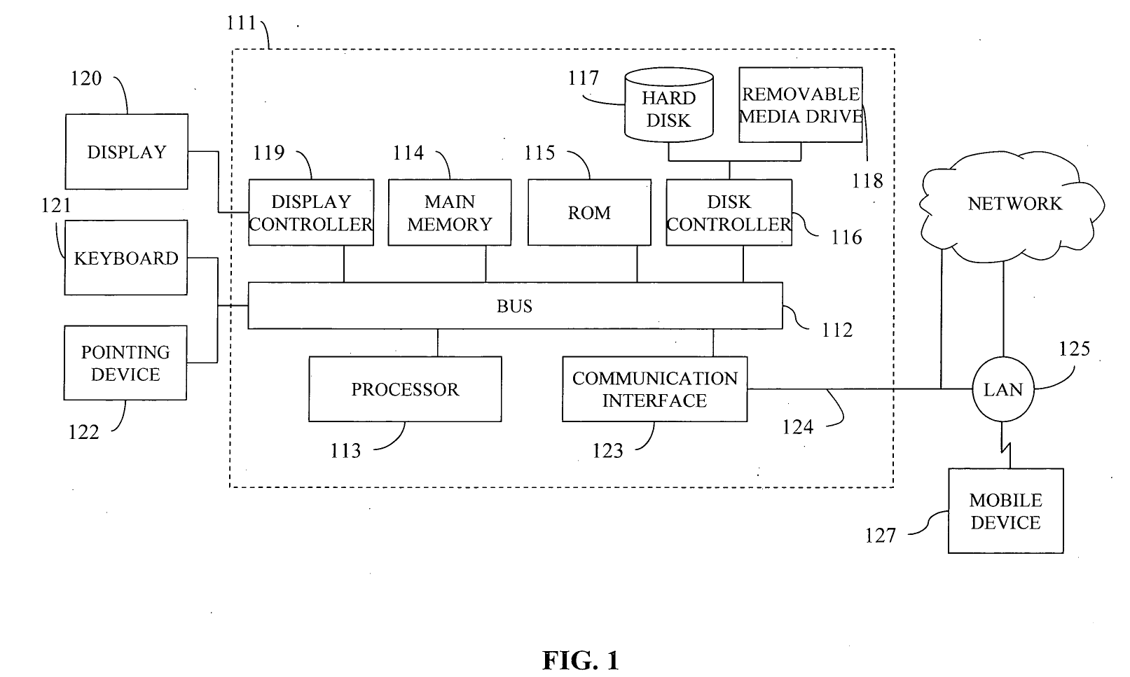

FIG. 1 illustrates a computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further may include a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read only compact disc drive, read/write compact disc drive, compact disc jukebox, tape drive, and removable magneto optical drive). The storage devices may be added to the computer system 111 using an appropriate device interface (e.g., small computer system interface (SCSI), Serial Advanced Technology Attachment (Serial ATA or SATA), Parallel ATA or PATA, integrated device electronics (IDE), enhanced-IDE (EIDE), direct memory access (DMA), or ultra DMA).

The computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to the bus 112 to control a display 120, such as a cathode ray tube (CRT), liquid crystal display (LCD) or any other type of display, for displaying information to a computer user. The computer system includes input devices, such as a keyboard 121 and a pointing device 122, for interacting with a computer user and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi processing arrangement may also be employed to execute the sequences of instructions contained in main memory 114. In alternative embodiments, hard wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, USB drives, magneto optical disks, PROMs (EPROM, EEPROM, flash EPROM), DRAM, SRAM, SDRAM, or any other magnetic medium, compact discs (e.g., CD ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non volatile media includes, for example, optical, magnetic disks, and magneto optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of spectra including but not limited to radio, light, infrared, and microwave frequencies.

Various forms of computer readable media may be involved in carrying out one or more sequences of one or more instructions to processor 113 for execution. For example, the instructions may initially be stored on a magnetic disk of a remote computer. The remote computer can load the instructions for implementing all or a portion of the present invention remotely into a dynamic memory and send the instructions over a network. The computer system 111 may receive the instructions across the network and execute them. The instructions received by the computer system 111 may optionally be stored on storage device 117 or 118 either before or after execution by processor 113.

The computer system 111 also includes a communication interface 123. The communication interface 123 provides a two way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 123 sends and receives electrical, electromagnetic or optical signals that carry various types of information.

The network link 124 typically provides data communication through one or more networks to other data devices. For example, the network link 124 may provide a connection to another computer or remotely located presentation device through a local network 125 (e.g., a LAN) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA), laptop computer, or cellular telephone or any other mobile device known to one having ordinary skill in the art. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

This computer system may be implemented with any of the embodiments described herein. Alternatively, in other exemplary embodiments, the entire computer system may be replicated any number of times and used with any of the embodiments described herein. Additionally, any part of the computer system, for example the processor, may be replicated any number of times to implement any of the embodiments of the invention.

Other aspects of the invention may include data transmission and Internet-related activities. See Preston Graila, How the Internet Works, Ziff Davis Press (1996), which is hereby incorporated by reference into this patent application. Still other aspects of the invention may utilize wireless data transmission, such as those described in U.S. Pat. Nos. 6,456,645, 5,818,328 and/or 6,208,445, all of which are hereby incorporated by reference into this patent application.

In one exemplary embodiment, an Automated Intelligent Parallel Processing Solution (AIPPS) enabled open Enterprise Architectural Framework (EAF) (200) may include a Collaborative Environment (CE) component (202), a Methodology and Process Environment (MPE) component (204) and a Knowledge Enablement and Augmentation (KEA) environment component (206) that are substantially operatively networked via an Intelligent Broker (IB) component/module (208). In a further exemplary embodiment, an enabled and integrated EAF (200) system and method may provide a single point of authentication and entry to multiple information sources and applications with a customizable user interface. It may provide a cluster of key functions to encapsulate specific support for the enabled and integrated EAF operations such as: capturing and managing requirements, Use Case modeling and tradeoff analysis, building templates, and generating and communicating reports.

### Methodology and Process Environment

In one exemplary embodiment, an Automated Intelligent Parallel Processing Solution (AIPPS) system and method for integrating an Enterprise Architectural Framework (EAF) (200) having a Methodology and Process Environment (MPE) component (204) may have an intelligent and adaptable parallel business process module that may comprise an Initiation sub-process (210), an Evaluation sub-process (212), a Formulation sub-process (214) and a Communication sub-process (216).

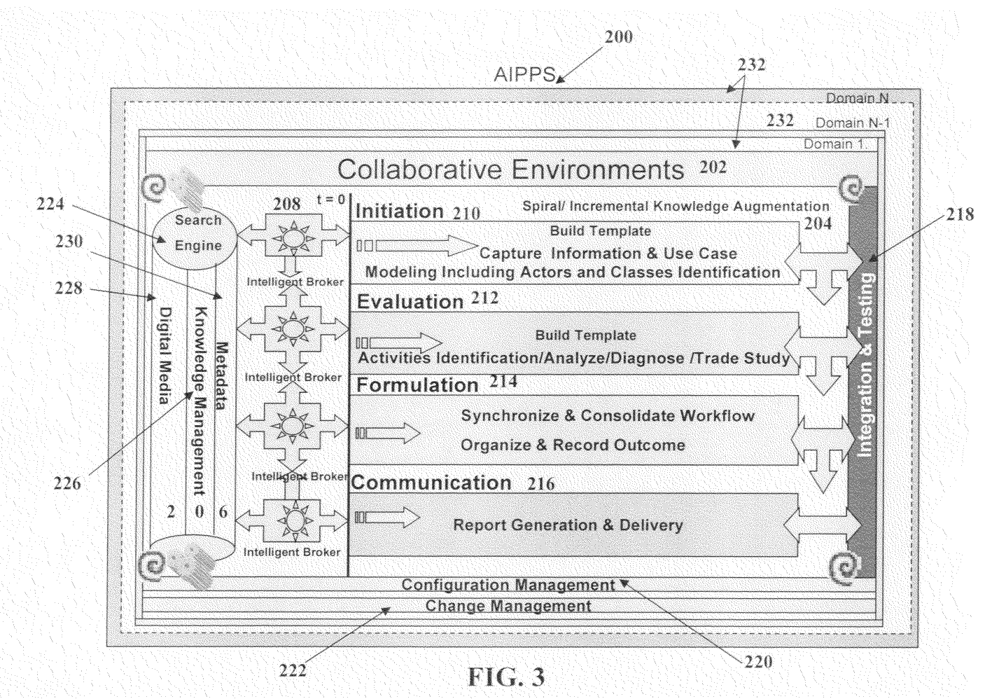

An AIPPS enabled EAF system and method (200) according to the present embodiment having a Methodology and Process Environment (MPE) component (204) and further embodiments that may utilize the architectural framework system and method (200) as shown in, for example, FIGS. 2 and 3 to assist in enabling the realization of successful “end to end” Electronic Human Services (EHSs). The AIPPS system and method (200) of the present exemplary embodiment may also apply a continuous spiral development methodology that may effectively model the scenario entered by a user(s), capture its corresponding interactive template, and ultimately provide solutions which meets the users' needs. This methodology may reduce uncertainty and addresses solution risks earlier in the development lifecycle than traditional existing methods.

The AIPPS (200) of the present exemplary embodiment may deliver and demonstrate solution capability at each iteration of the spiral development cycle. Each spiral or solution build can have its own requirements, entrance criteria, functionality/capability, required modeling, risk mitigations, demonstration and test requirements, and exit criteria. Each spiral or solution may be able to further expand on the capability proven at the test phase of the previous spiral cycle. Common Unified Modeling Language (UML) techniques (including Use Case, Business Process, Class, Object Sequence, Collaboration, and State Transition Diagrams), and defined processes may be followed during the builds to capture additional functionality as well as other techniques and processes known to one having ordinary skill in the art. Developed solution capability may then be integrated and tested (218). Continuous testing (218) can occur throughout the spiral iteration. Indeed, no solution integration may go without passing through incremental testing (218). This engineering development best practice may be performed in a coherent and integrated manner across the scenario's lifecycle to ensure early detection and removal of defects, ensure checks and balances, and reduce the overall realization cycle time and cost of the scenario.

The above discussed spiral methodology of the AIPPS is an intelligent and adaptable parallel Business Process (as shown in, for example, FIGS. 3 & 4) for establishing a requirements baseline to ensure completeness and reduce defects, providing traceability of customer requirements through acceptance criteria and verifying, through disciplined and traceable testing, that the customer requirements are successfully delivered according to acceptance criteria. Through this business process, the MPE (204) and associated methodology can focus on defining users' needs and may require functionality early in the scenario's lifecycle, documenting, validating, and verifying requirements and design while considering the complete solution effects, such as cost, time, performance, support, and testing. In further exemplary embodiments, the enabled and integrated EAF system and method (200) and components thereof may apply a suite(s) of tools, metrics, and multi concurrent sub-processes to create a baseline that drives toward a successful solution.

Further, in this or other embodiments, the Business Process may integrate and test four concurrent sub-processes that are described here as Initiation (210), Evaluation (212), Formulation (214), and Communication (216). These sub-processes can proceed from scenario concept capturing, to analysis, to design, and to communication where the goal of providing balanced decision realization may be sought. Thus, these sub-processes may lead to administrative cost and oversight reduction, business process optimization for maximizing effectiveness while ensuring efficiency, and accommodating change in mission from one domain of operation to another.

### Business Process Sub-Processes

1. INITIATION (210), usually the first step, is directed to achieving concurrence among all stakeholders regarding the scenario's lifecycle objectives and corresponding Use Cases. In some cases, the end of the current Initiation step may coincide with the start of the next iteration for incorporating or augmenting knowledge and gaining confidence.

The primary activities of Initiation (210) may include, for example, first defining the scope of the scenario for capturing the context and boundary conditions, including significant requirements, functionalities, operational concepts, candidate design/solution for tradeoffs, constraints, suitable tools and processes, and acceptance criteria. This step may include identifying the actors who are involved directly in the scenario. Each actor is a UML Class, where it can be defined by Name, Responsibilities, Associations, Inheritance relationships, Composition associations, Interfaces, Vocabularies and the like known to a person having ordinary skill in the art. Also, Initiation (210) may define what each actor wants to do with the scenario. Each of these defined activities can become a Use Case.

Thus, the Initiation step (210) may conduct feasibility and tradeoff analysis for evaluating candidate design/solution alternatives against some of the scenario primary Use Cases, and mitigating risk to gain confidence. Next, for each of those Use Cases the step/sub-process may decide on the most usual course or workflow to capture its basic course and description. Once satisfied with the basic course it may then consider alternatives (if applicable) and add those as extending Use Cases. Also, Initiation (210) may review each Use Case description against the descriptions of the other Use Cases to address commonality for identifying common courses for used Use Cases.

Initiation (210) may proceed to use a Collaboration Diagram model to ensure proper identification of classes, ensure proper alignment and utilization of the enabled and integrated EAF components of this and other embodiments. Further, the sub-process may leverage lessons learned from the Knowledge Management (KM) environment (206), which may result in redefining the scope of the scenario, taking into consideration alternative analysis or reconsideration of the requirements.

Initiation (210) may also repeat the process for each actor, use Configuration Management (220) and Change Management (222) (described below) to record templates' configuration and capture changes, use a State Transition Diagram governed by relevant events, preconditions, and consequences to show the propagation of progress going from one sub-process to another toward completing the scenario at hand.

2. EVALUATION (212) is the second step of the AIPPS system and method (200) for one exemplary embodiment where it may baseline the scenario, ensure the stability of the requirements and design, mitigate risks in order to predict the completion of the scenario, and to set up the supporting environment for tailoring relevant tools, processes, and templates. In some cases, the end of the current Evaluation step (212) may coincide with the start of the next iteration.

The primary activities of this step (212) may include, for example, establishing a solid understanding of the most critical requirements and functionalities that drive the scenario's planning, base design, and validation decisions.

This step (212) may also include establishing and providing a baseline detailed design iteration plan using a Sequence Diagram model by: (i) taking the Use Case description and turning it into simple outline to include the necessary steps or tasks; (ii) identifying the classes involved in the Use Case and responsible for performing identified tasks; (iii) examining each task for possible break down into a number of simpler tasks, adding in probes to examine relationships in the Use Case, and to check for and resolve critical errors that perhaps were not covered in the Use Case model; and (iv) considering whether anything discovered at this stage needs to be fed back into the Use Case model.

Further, this step (212) may include using a Collaboration Diagram model to ensure proper implementation of classes, ensure proper alignment and utilization of components of this or further embodiments, leverage lessons learned from the KM solution which may result in a redesign of the initial outcome, and take into consideration alternative designs or reconsideration of the requirements.

Furthermore, this step (212) may include any of the following: refining the scenario's design and selected components for initial integration and performance assessment against the primary functionalities; identifying processes, tools, and workflow automation for supporting the formulation activities; using Configuration Management (220) and Change Management (222) to record templates' configuration and capture changes; and using a State Transition Diagram governed by relevant events, preconditions, and consequences to show the propagation of progress going from one sub-process to another toward completing the scenario at hand.

3. FORMULATION (214) may be the third step of the AIPPS for one exemplary embodiment where it can complete the execution of the scenario based upon the best design/solution candidate. This step (214) may follow a structured workflow process, with emphasis on managing resources and controlling interactions to satisfy exit criteria, optimize relevant metrics, and ensure quality. In some cases, the end of the current Formulation step (214) may coincide with the start of the next iteration.

The primary activities may, for example, include: establishing and synchronizing workflow to achieve some degree of parallelism to accelerate the execution of the Formulation activities; using a Collaboration Diagram model (e.g. to ensure proper alignment and utilization of any or all components of this or further embodiments and to leverage lessons learned from the KM which may result in restating the decision, taking into consideration alternative formulation or reconsideration of the requirements); managing and controlling resources to ensure process optimization and avoiding unnecessary rework, then, complete the analysis, design, implementation, and testing against the defined evaluation criteria, assessing decision outcomes against the scenario's acceptance criteria to ensure adequate quality; using Configuration Management (220) and Change Management (222) to record templates' configuration and capturing changes, and using a State Transition Diagram governed by relevant events, preconditions, and consequences to show the propagation of progress going from one sub-process to another toward completing the scenario at hand.

4. COMMUNICATION (216) may be the fourth step/sub-process of the AIPPS (200) for one exemplary embodiment where it can ensure that a finalized decision and supporting/associated materials are generated and ready for delivery to relevant users; and for getting users' feedback.

The primary activities of this step (216) may, for example, include: utilizing a range of computer and communication technologies, such as instant messaging, e-mail, chat room, discussion databases, mobile communicators, shared white board, and streaming media including audio, video or web conferences; coordinating and collaborating via web and between various users spread across multiple domains, sites and time zones to accomplish a shared task and to reach a decision(s); using Configuration Management (220) and Change Management (222) to record templates' configuration and capture change; and using a State Transition Diagram governed by relevant events, preconditions, and consequences to show if there is a need to transition to a prior sub-process to ensure the completeness and accuracy prior to final result reporting of the scenario at hand.

By the end of this communication step (216) all of the scenarios' objectives may have been met and the scenario should be in a position to be closed out. In some cases, the end of the current scenario (216) may coincide with the start of another, leading to the next iteration.

### Configuration Management

In an exemplary embodiment, an AIPPS enabled and integrated EAF system and method (200) maintains a Configuration Management (CM) component (220). The CM component (220) may cover problem-domain development artifacts, scenarios, requirements, test cases, and documentation. A CM process (220) according to this embodiment may use an activity based approach, associating the changes to configuration items. Activity based change management is considered to be a way to simplify and improve change capability. It may manage the integration that the entire tool set requires for Use Case development, and can track individual changes to software assets and documents throughout the lifecycle. It also may streamline and simplify the scenario development process, enabling problem domain specialists to construct scenarios quickly and more efficiently.

### Change Management

In an exemplary embodiment, an AIPPS enabled and integrated EAF system and method (200) may implement a change management process/component (222) that is intended to control all the unforeseen changes that may arise during the course of scenario development. This process/component (222) manages the effects that could otherwise jeopardize procedures and performance, affect scope, solution definition, deliverable definition, and the quality of the final result.

The change management procedure (224) can be launched when a need for a change arises. The end result of the procedure may be that “the change is implemented”, “the change is deferred”, or “the change is rejected”.

### Collaborative Environment

In an exemplary environment, an AIPPS enabled and integrated EAF system and method (200) may have a Collaborative Environment (CE) component (202) to allow participants to communicate, coordinate and collaborate. The CE (202), and the present embodiment overall, may apply Web Browser Intelligence (WBI) to keep track of a user's Internet activity which may simplify Web browsing for the user.

### Intelligent Broker (IB) Environment

In an exemplary embodiment, an AIPPS enabled and integrated EAF system and method (200) may apply an Intelligent Broker (IB) component/module (208) that may be used to build a substantially flexible, extensible and secure architectural framework; to manage real time events between clients, servers, and mobile devices providing a highly scalable, event driven model to integrate applications and people regardless of device or location. Further, an IB (208) may improve framework flexibility and adaptability using powerful middleware for heterogeneous application connectivity and integrity, message distribution, message routing and transformation. An IB (208) may support database integration for message logging, merge, and update. An IB (208) may also provide an affordable distributed integration platform ideal for distribution across the enterprise with the capability to add custom extensions into the plug-ins framework. Additionally, an IB (208) may use multiple transports supporting HTTP tunneling and quality of protection enabling enterprises to confidently and securely communicate across the Internet.

### Knowledge Enablement and Augmentation Environment

In an exemplary embodiment, an AIPPS-enabled and integrated EAF system and method (200) may include a Knowledge Enablement and Augmentation (KEA) environment component (206) that may further comprise a Search Engine component (224), a Knowledge Management (KM) component (226) and a Digital Media Solution (DMS) component (228).

### (1) Search Engine

The search engine (224) may be a full text search engine written in Java (or any other language known to one having ordinary skill in the art). The use of Java and Internet protocols, for example, may allow easy integration and communication with cross platform applications. It also may enable users to incorporate new document types and to easily customize new user interfaces. The KEA (206) may use metadata (230) (the tags that are associated with documents such as author names, descriptions, and keywords) to enhance the search. Search features may include free text query specification, advanced query operators, multi lingual support, summarization, search results clustering, and index compression.

### (2) Knowledge Management

This KM subcomponent (226) may provide technology and processes enabling user communities to exchange and optimize knowledge and experiences to help them reach optimal decision. A KM component (226) may include these additional subcomponents:
(1) Expertise—the specialized knowledge, skill or ability which is embodied in an individual (tacit knowledge);
(2) Content—explicit knowledge, information and data which is represented in artifacts;
(3) Collaboration—the activity of working with others, especially in a joint intellectual effort
(4) Self-service tools, applications and knowledge repositories that help link user communities to their work; and
(5) Learning—the activity of getting knowledge or understanding facts, ideas, or how to do things.

In a further embodiment, a KM subcomponent (226) may include numerous other subcomponents such as an on-line database/content management system, shared work spaces, document management systems, virtual conferencing capabilities, computer-based training, and helpdesk system. The KM subcomponent (226) may capture, create, disseminate, and leverage knowledge for the purpose of increasing overall performance. The KM subcomponent (226) may also facilitate embodiments of the AIPPS-enabled EAF system and method (200) in accessing and mining structured information stored in data warehouses and unstructured information stored in documents accessible across the Internet. In further embodiments, a KM subcomponent (226) may have security features defined by user roles and organization. The application of a KM subcomponent (226) may enable clients to create new knowledge (refine/validate), increase learning across user communities, disseminate knowledge (multicast), and act more effectively (improved decision-making).

### (3) Digital Media

In an embodiment of the AIPPS-enabled and integrated EAF system and method (200), a Digital Media Solution (DMS) subcomponent (228) may be incorporated. The technology associated with this subcomponent (228) can help user communities to leverage digital media in various steps of its process. The DMS subcomponent (228) may be an open, standards-based framework component that integrates hardware and/or software and may enable flexible, low costs solutions that will be able to evolve as new technologies emerge. In further embodiments, a DMS subcomponent (228) may include capabilities such as:
(1) Digital Content Creation capability which provides state-of-the art 3D animation, and content editing;
(2) Digital Content Management capability which provides an end-to-end solution for management, archiving and retrieval of content for clients who require support for scenario execution;
(3) Digital Media Commerce capability which enables clients to search, view, manage, collaborate, purchase, sell and download digital assets directly through the Internet;
(4) Secure Content Distribution capability which delivers a comprehensive solution for digital content distribution and rights management that can be applied to various types of content—including audio, video, text and image;
(5) Broadcast Content Distribution capability which distributes digital content including audio, video, text and image over IP multicast networks, and provides basic desktop editorial and review processing;
(6) Audio Asset Management capability which provides a high-end audio broadcasting solution with the ability to automate the broadcast of digital content over multiple channels in a cost-effective way;
(7) Broadcast Asset Management capability which provides a comprehensive infrastructure tool set to leverage IT technologies for optimal resource utilization and performance; and
(8) Digital media infrastructure and consolidation capability to optimize the scalability of the storage system, support heterogeneous broadcast operations, and to help transform broadcasting from analog to digital.

### Component Service-Based Architecture

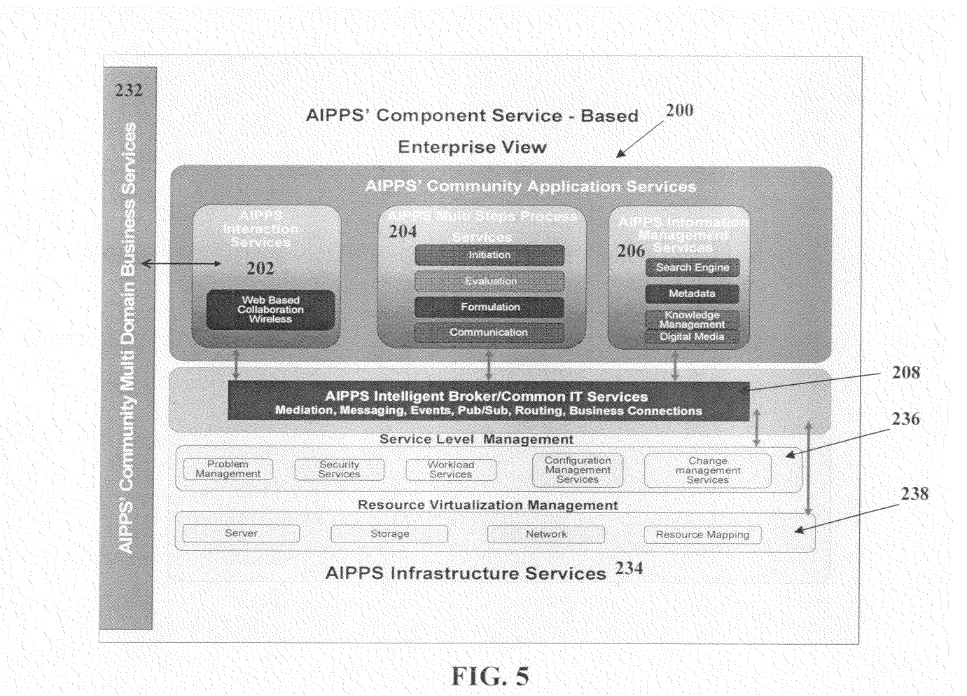

In at least one exemplary embodiment, an AIPPS-enabled and integrated EAF system and method (200) may follow the implementation of a component service-based architecture as shown in FIG. 5. This can provide the ability for components to advertise the services that they may perform so that the EAF system and method (200) may add and remove services as needed. These services may correspond to Business Services.

Vertically, from the left side, FIG. 5 shows: Community Multi Domain Business Services (232) which may be the processes that create value for the user community and are determined by the particular problem domain. From the top, we have Community Application Services (200) which may provide the application frameworks to execute selected enabled and integrated EAF's community domain Business Service (232). The application services may include Interaction (202), Multi Processes (204), Information Management (206), and Intelligent Broker/Common IT Services (208). These services may provide a common, repeatable method for accessing, creating pools of commonly used infrastructure resources, processing, managing, and disseminating finalized decision's information. Applications communicate with each other and interact with the infrastructure via the Intelligent Broker (IB) module/component services (208).

From the bottom, the Infrastructure Services component (234) may provide pools of processing and networking resources for applications. The exemplary enabled and integrated EAF system and method (200) of FIG. 5 drives down to the Service Level Management component (236), which may automate the provisioning of the servers in case of failures. Underlying all these capabilities is a set of Resource Virtualization Services Management (238) which may simplify the infrastructure; reduce management complexity; increase resource utilization; reduce cost; improve the effectiveness of IT as it treats resources of individual servers, storage, and networking products to function as a single pool or entity, allowing access and management of resources across an organization more efficiently, by effect and need rather than physical location.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above described embodiments should be regarded as illustrative rather than restrictive. Accordingly, it should be appreciated that variations to those embodiments can be made by those skilled in the art without departing from the scope of the invention as defined by the following claims.

What is claimed is:

1. An enterprise architectural framework comprising:
a first computer;
a methodology and process environment component;
a collaborative environment component;
a knowledge enablement and augmentation environment component, wherein said components are operatively interconnected via an intelligent broker component; and
wherein said collaborative environment component further comprises:
a customizable user interface.

2. The enterprise architectural framework of claim 1 further comprising:
a second computer and a network interconnecting said first computer to said second computer.

3. The enterprise architectural framework of claim 2 wherein said methodology and process environment component further comprises:
an intelligent and automated parallel business process module having an initiation sub-process, an evaluation sub-process, a formulation sub-process, and a communication sub-process.

4. The enterprise architectural framework of claim 3 wherein said knowledge enablement and augmentation environment component further comprises:
a search engine, a knowledge management solution, and a digital media solution.

5. The enterprise architectural framework of claim 4 further comprising:
a component that provides logic to enforce a spiral design methodology for the design of said methodology and process environment component, said collaborative environment component, said knowledge enablement and augmentation environment component, and said intelligent broker component.

6. The enterprise architectural framework of claim 5 further comprising:
a configuration management component.

7. The enterprise architectural framework of claim 6 further comprising:
a change management component.

8. The enterprise architectural framework of claim 4 wherein said methodology and process environment component further comprises:
logic to carry out health care business processes.

9. The enterprise architectural framework of claim 4 wherein said methodology and process environment component further comprises:
logic to carry out finance business processes.

10. The enterprise architectural framework of claim 4 wherein said methodology and process environment component further comprises:
logic to carry out commerce business processes.

11. The enterprise architectural framework of claim 4 wherein said methodology and process environment component further comprises:
logic to carry out entertainment business processes.

12. The enterprise architectural framework of claim 4 wherein said methodology and process environment component further comprises:
logic to carry out communication business processes.

13. The enterprise architectural framework of claim 4 wherein said methodology and process environment component further comprises:
logic to carry out transportation business processes.

14. The enterprise architectural framework of claim 4 wherein said methodology and process environment component further comprises:
logic to carry out industrial business processes.

15. The enterprise architectural framework of claim 4 wherein said methodology and process environment component further comprises:
logic to carry out travel business processes.

16. The enterprise architectural framework of claim 4 wherein said methodology and process environment component further comprises:
logic to carry out recreation business processes.
